(19) United States
(12) Patent Application Publication
(10) Pub. No.: US 2015/0330498 A1
(43) Pub. Date: Nov. 19, 2015

(54) PLANET PIN FOR THE LUBRICATION OF PLANETARY BEARINGS

(71) Applicant: Schaeffler Technologies AG & Co. KG, Herzogenaurach (DE)

(72) Inventors: Ryan Carlino, Charlotte, NC (US); Charles M. Schwab, Fort Mill, SC (US); Alfred Thomas, Mint Hill, NC (US)

(73) Assignee: Schaeffler Technologies AG & Co. KG, Herzogenaurach (DE)

(21) Appl. No.: 14/693,952

(22) Filed: Apr. 23, 2015

Related U.S. Application Data
(60) Provisional application No. 61/993,027, filed on May 14, 2014.

(51) Int. Cl. F16H 57/04; F16H 57/08

(52) U.S. Cl. CPC F16H 57/0479; F16H 57/08; F16H 57/043; F16H 57/0482

(57) ABSTRACT

A planetary pin for use in a planetary gear system is provided. The planetary pin comprises a cylindrical body, a first end, an axial passage extending from the first end, and a wall thickness between the axial passage and an outer surface of the body. A cylindrical lateral passage is formed through the wall thickness axially displaced from the first end and in fluid communication with the axial passage. A slot formed in the first end from the outer surface to intersect with the axial passage. A planetary pin assembly using the planetary pin is provided in which the slot in the first end of the pin cooperates with a planetary carrier to accept and direct lubricant to the lateral passage through the axial passage.

### CROSS REFERENCE TO RELATED APPLICATIONS

This application claims the benefit of U.S. patent application Ser. No. 61/993,027 filed on May 14, 2014, which is incorporated by reference as if fully set forth.

### FIELD OF INVENTION

Embodiments of the present invention generally relate to planetary gear systems using planetary bearings in power transmission mechanisms. More specifically, embodiments of the present invention relate to a planetary pin for delivering lubricating fluids to a planetary gear and a planetary pin assembly using same.

### BACKGROUND

Some power transmission mechanisms, for example automotive transmissions, employ planetary gearsets requiring lubrication for reliable operation and thermal stability. In some transmissions, planet pins have fluid passages drilled through the pin body to deliver a lubrication fluid, for example oil, from a source such as an “oil dam” or a “lube catcher” to a raceway of a planetary bearing during operation. The flow of the oil requires rotation of the planetary gear carrier to generate centrifugal head to push the oil into the planet pin fluid passages.

Current planetary gear systems may include a planet pin having a lubrication port formed through the pin wall to provide a flow of oil. The lubrication port may be fed with lubricant from a passage formed at an acute angle with the longitudinal axis of the planet pin. Drilling at an angle through bearing-grade steel can be a multi-step and complicated drilling operation. Therefore a need exists for a more easily manufactured planet pin.

In other known pins, the lubrication port may be the opening of a radial passage in fluid communication with an axial passage. An oil dam or lube catcher directs an oil flow into and through the axial passage and radial passage.

Axial space is at a premium in modern automotive transmission applications. Current planet pins utilize drilled radial holes as lubrication ports to supply the oil into the planet pin, or as features used to fix the pin in the planetary carrier which can increase the overall axial length of the planet pin.

Accordingly, a need exists for an improved planet pin for use in a planetary gear system.

### SUMMARY

Embodiments of a planet pin for use in a planetary gear system and a planetary pin assembly using the planetary pin are provided. In one embodiment, the planetary pin comprises a cylindrical body having an outer surface, a first end, an inner surface defining an axial passage extending from the first end, and a wall thickness between the inner surface forming the axial passage and the outer surface. A cylindrical lateral passage is formed through the wall thickness in fluid communication with the axial passage. A slot is formed in the first end from the outer surface and intersecting with the axial passage.

In one embodiment, a planetary pin assembly comprises a planetary carrier having a body including a planetary pin receptacle formed as a blind hole and an oil feed extending radially from a center of the body to the planetary pin receptacle adjacent to a bottom of the blind hole. The assembly further comprises a planetary pin with a cylindrical body having an outer surface, a first end, an inner surface defining an axial passage extending from the first end, and a wall thickness between the inner surface forming the axial passage and the outer surface. A cylindrical lateral passage is formed through the wall thickness in fluid communication with the axial passage. A slot is formed in the first end from the outer surface and intersecting with the axial passage. The bottom of the blind hole, the first end of the planetary pin, and a portion of a wall defining the blind hole form a plenum for receiving and directing an oil flow from the center of the body to the axial passage.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a planetary pin in accordance with an embodiment of the present invention.

FIG. 2 is an end view of the planetary pin according to FIG. 1.

FIG. 3A is a side cross sectional view of the planetary pin of FIG. 1

FIGS. 3B and 3C are first end and second end views of the planetary pin of FIG. 1.

FIG. 4 is a partial sectional side view of a portion of a planetary pin assembly in accordance with an embodiment of the present invention.

To facilitate understanding, identical reference numerals have been used, where possible, to designate identical elements that are common in the figures. The figures are not drawn to scale and may be simplified for clarity. It is contemplated that elements and features of one embodiment may be beneficially incorporated in other embodiments without further recitation.

While described in reference to an automotive transmission, the present invention may be modified for a variety of applications while remaining within the spirit and scope of the claimed invention, since the range of the potential applications is great, and because it is intended that the present invention be adaptable to many such variations.

### DETAILED DESCRIPTION

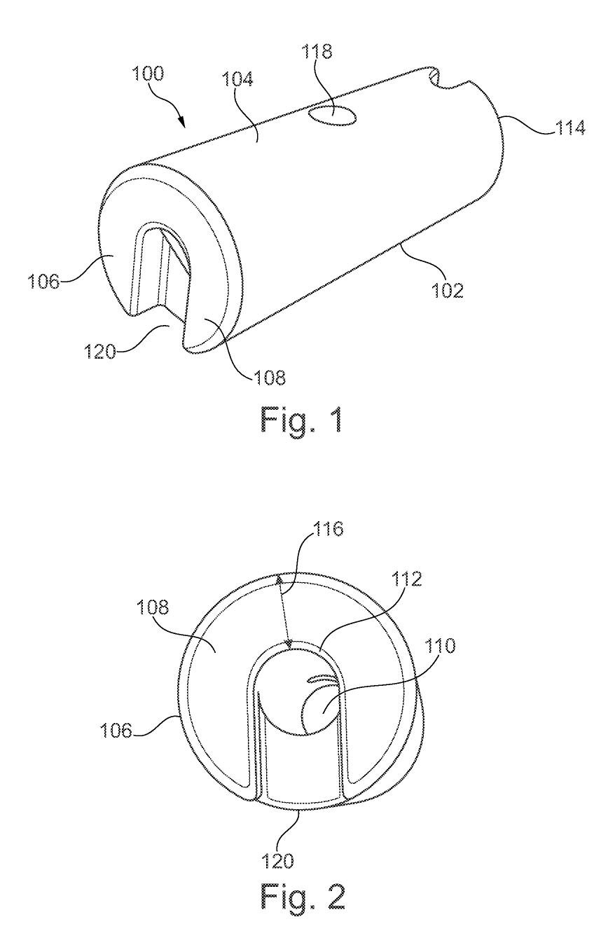

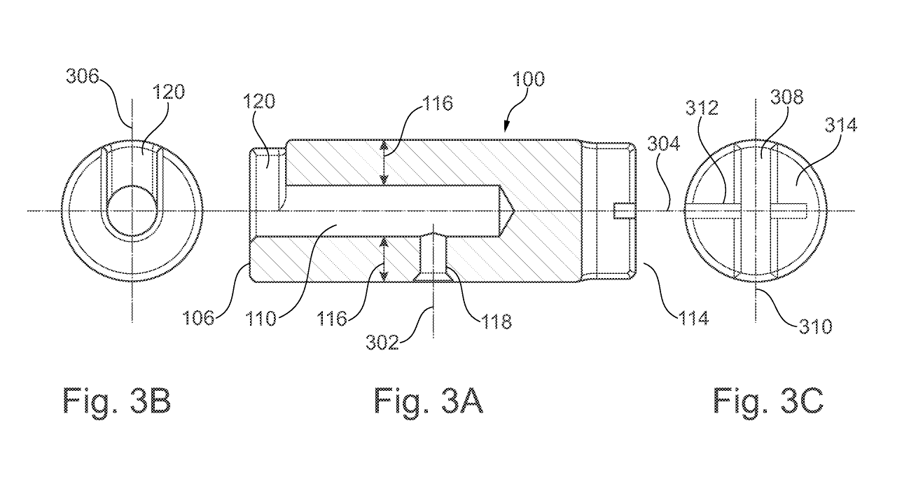

FIG. 1 depicts a perspective view of a planet pin 100 in accordance with an embodiment of the present invention. The pin has a generally cylindrical body 102 with an outer surface 104 and a first end 106 with a first end surface 108. The cylindrical body 102 has an axial passage 110 extending from the first end 106 as may be seen in the end view illustrated in FIG. 2. The axial passage 110 is generally concentric with the longitudinal axis 304 (FIG. 3) of the planetary pin 100. A generally cylindrical inner surface 112 defines the circumferential bounds of the axial passage 110. The axial passage 110 may be formed by any suitable process, such as drilling. The cylindrical inner surface 112 of the axial passage 110 and the outer surface 104 form the bounds of wall thickness 116. The planetary pin may be formed from any material suitable for supporting a bearing, for example bearing-grade steel.

A generally cylindrical lateral passage 118 is formed through the wall thickness 116 at a location offset from the first end 106 along a longitudinal axis 304 (FIG. 3) and in fluid communication with the axial passage 110. The lateral passage 118 may be formed by any suitable process, for example drilling. In the embodiment illustrated in FIG. 3, the lateral passage 118 is formed so that the axis 302 of the lateral passage 118 is perpendicular to the longitudinal axis 304 of the planetary pin 100. In other embodiments, the axis 302 may oriented at an acute angle with the longitudinal axis 304.

The axis 302 of the lateral passage 118 may extend along a radius of the planetary pin 100 and terminate in the axial passage 110 as illustrated in FIG. 3. In an embodiment, the lateral passage 118 may extend along a diameter through the wall thickness 116 and the axial passage 110, and at least partially through the wall thickness 116 on the opposite side of the axial passage 110 (not shown). In other embodiments, the lateral passage 118 may be formed on a chord of the circular cross section of the cylindrical body 102 that does not intersect with the longitudinal axis 304.

A slot 120 is formed in the first end 106 of the planetary pin 100 from the outer surface 104 towards the axial passage 110 so that the slot 120 and the axial passage 110 are in fluid communication. In the embodiment illustrated in FIG. 3, slot 120 is a radial slot formed so that the axis 306 of the slot 120 intersects with axis 304 of the axial passage 110. In other embodiments, the axes 304, 306 need not intersect in order for the axial passage 110 and the slot 120 to be in fluid communication. The axis 306 of the slot 120 may be rotationally offset from the axis 302 of the lateral passage 118 about the longitudinal axis 304. In the non-limiting embodiment of FIG. 3, the slot 120 is rotationally offset form the lateral passage 118 by about 180 degrees (i.e., the axes 306 and 302 are rotationally offset by about 180 degrees).

The slot 120 may extend beyond the axial passage 110 and may, in some embodiments, be formed along a diameter through the wall thickness 116 and the axial passage 110, and at least partially through the wall thickness 116 on the opposite side of the axial passage 110. Thus, the slot 120 may be a through slot (not shown).

In one embodiment, the second end 114 of the planetary pin 100 includes a fixing slot 308 formed through the diameter of the planetary pin 100. In some embodiments, the axis 310 of the fixing slot 308 is parallel with the axis 306 of the slot 120 as illustrated in FIG. 3. In other embodiments, the axes 306, 310 are not parallel.

In the embodiment illustrated in FIG. 3, the second end 114 include an orientation slot 312 formed in the second end 114 through a second end surface 314 from the outer surface 104 to the fixing slot 308. As illustrated, the orientation slot 312 may extend beyond the orientation slot 312 and may pass completely through the cylindrical body 102.

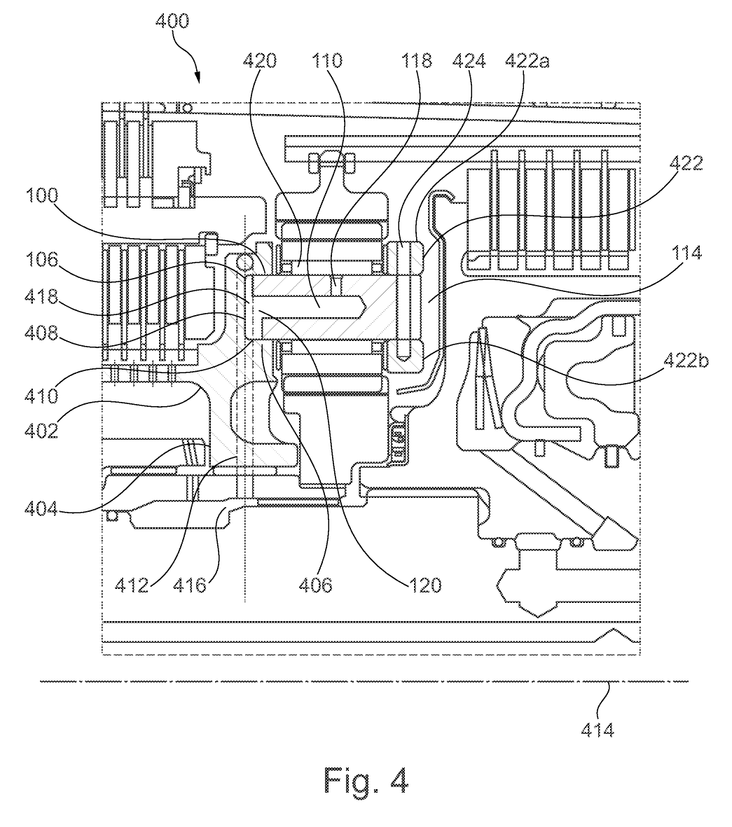

FIG. 4 depicts a planetary pin assembly 400 including a planetary carrier 402 and a planetary pin 100. The planetary carrier 402 includes a body 404 including a planetary pin receptacle 406. The planetary pin receptacle 406 in the embodiment of FIG. 4 is formed as a blind hole having a bottom 408 and a cylindrical side wall 410 defining the blind hole. A lubricant feed channel, oil feed 412, extends radially from a lubricant supply 416 centrally located in the body 404 proximate to the axis of rotation 414 of the body 404 to the planetary pin receptacle 406 adjacent to the bottom 408 of the blind hole forming the planetary pin receptacle 406. The oil feed 412 is in fluid communication with the planetary pin receptacle 406.

In the planetary pin assembly illustrated in FIG. 4, the planetary pin 100 is inserted into the planetary pin receptacle 406 with the first end 106 leading into the planetary pin receptacle 406 such that a portion of the first end surface 108 abuts against the bottom 408 with the slot 120 aligned with the oil feed 412. The bottom 408, a portion of the cylindrical side wall 410, and the first end 106 of the planetary pin 100 form a plenum 418 in fluid communication with the axial passage 110. A lubricant, for example oil, supplied by the oil feed 412 is received in the plenum 418 and directed to the axial passage 110 and through the lateral passage 118 to lubricate a bearing 420 disposed on the planetary pin 100.

A portion of the body 404 spaced apart from the bottom 408 includes a flange 422 including a passage 424 formed through a first portion 422a and at least partially through the second portion 422b. When installed in a preferred orientation, the fixing slot 308 at the second end 114 of the planetary pin 100 is aligned with the passage 424. A fixing pin, for example a roll pin or dowel pin, may be disposed through the portion of the passage 424 formed in flange first portion 422a and pass through the fixing slot 308 and received at least partially into the second portion 422b. At least one of the first and second portions 422a and 422b are sized to accept the fixing pin in an interference fit and the fixing slot 308 receives the fixing pin with clearance to minimize the rotation of the installed planetary pin 100 about the longitudinal axis 304.

The inventors have noted that by creating a slot 120 at the first end 106 of the planetary pin 100 to form a plenum 418 when the pin is installed in the planetary carrier 402, the length of the pin may advantageously be reduced. Typical planetary pins require a full wall around the ports used to provide lubrication to the planetary bearing. By eliminating one wall of the lubricant supply passage to the pin, the pin length is reduced by approximately one wall thickness.

A similar benefit is realized at the second end 114 of the planetary pin 100. Typical planetary pins require a full wall around the passages used to receive a fixing pin to fix the planetary pin against undesirable rotation. The inventors have noted that by providing a slot in the second end 114, the planetary pin axial length can be reduced by approximately one wall thickness.

Further benefits are realized in that each passage formed in the pin, axial passage 110, lateral passage 118, and slot 120, are formed normal to a surface of the planetary pin 100, avoiding complicated machining operations such as angled drilling through the cylindrical body 102 of the planetary pin 100.

Thus a planetary pin and a planetary pin assembly are provided herein. The inventive planetary pin and planetary pin assembly may advantageously have a reduced axial length compared to some known planetary pins and planetary pin assemblies. The inventive pin may also eliminate complicated machining operations in production of the pin, beneficially reducing manufacturing costs.

What is claimed is:

1. A planetary pin for use in a planetary gear system, the planetary pin comprising:
a cylindrical body having an outer surface, a first end, an axial passage extending from the first end, and a wall thickness between the axial passage and the outer surface;
a cylindrical lateral passage formed through the wall thickness in fluid communication with the axial passage; and
a slot formed in the first end from the outer surface and intersecting with the axial passage.

2. The pin of claim 1, wherein the lateral passage is offset from the first end along a longitudinal axis of the pin.

3. The pin of claim 1, wherein the slot is a radial slot.

4. The pin of claim 3, wherein the lateral passage is a radial passage.

5. The pin of claim 4, wherein the lateral passage is offset from the radial slot along a longitudinal axis of the pin.

6. The pin of claim 5, wherein the lateral passage is rotationally offset from the slot about the longitudinal axis of the pin.

7. The pin of claim 1, further comprising a second end opposite the first end having fixing slot formed through the pin.

8. A planetary pin assembly comprising:
a planetary carrier having a body including a planetary pin receptacle formed as a blind hole and an oil feed extending radially from a center of the body to the planetary pin receptacle adjacent to a bottom of the blind hole; and
a planetary pin planetary pin comprising:
a cylindrical body having an outer surface, a first end, an axial passage extending from the first end, and a wall thickness between the axial passage and the outer surface;
a cylindrical lateral passage formed through the wall thickness in fluid communication with the axial passage; and
a slot formed in the first end from the outer surface and intersecting with the axial passage,
wherein the bottom of the blind hole, the first end of the planetary pin, and a portion of a wall defining the blind hole form a plenum for receiving and directing an oil flow from the center of the body to the axial passage.

9. The planetary pin assembly of claim 8, wherein the slot is a radial slot, the lateral passage is a radial passage rotationally offset from the radial slot by about 180 degrees.

10. The planetary pin assembly of claim 8, wherein the planetary pin further comprises a second end opposite the first end having fixing slot formed through the pin, and wherein the fixing slot is sized to accept a fixing device to fix the planetary pin against rotation about the longitudinal axis.
